(19) United States
(12) Patent Application Publication
(10) Pub. No.: US 2025/0106022 A1
(43) Pub. Date: Mar. 27, 2025

(54) MULTI-LANE CRYPTOGRAPHIC ENGINE AND OPERATIONS THEREOF

(71) Applicant: CRYPTOGRAPHY RESEARCH, INC., San Jose, CA (US)

(72) Inventors: Michael Alexander Hamburg, ‘s-Hertogenbosch (NL); Arvind Singh, Dublin, CA (US); Lauren De Meyer, San Francisco, CA (US)

(21) Appl. No.: 18/291,010

(22) PCT Filed: Jul. 13, 2022
(86) PCT No.: PCT/US22/37024

§ 371 Date: Jan. 22, 2024

Related U.S. Application Data
(60) Provisional application No. 63/203,464, filed on Jul. 23, 2021.
(60) Provisional application No. 63/261,165, filed on Sep. 14, 2021.

(51) Int. Cl. H04L 9/30; G06F 17/16

(52) U.S. Cl. CPC H04L 9/3006; G06F 17/16

(57) ABSTRACT

Aspects of the present disclosure involve a cryptographic processor that includes four or more multiplication circuits, two or more addition circuits, and two or more memory circuits. The cryptographic engine is configured to perform a variety of operations, including modular multiplication, modular inversion, matrix multiplication, Montgomery multiplication, computations of Jacobi symbols, and the like. The cryptographic engine support streaming computations where at least some of the multiplication circuits operate on multipliers and/or multiplicands that are also used during other cycles of computations.

### TECHNICAL FIELD

The disclosure pertains to cryptographic computing applications, more specifically to improving efficiency of cryptographic operations with a cryptographic engine capable of parallel and streaming computations.

### BRIEF DESCRIPTION OF THE DRAWINGS

The present disclosure will be understood more fully from the detailed description given below and from the accompanying drawings of various implementations of the disclosure.

FIG. 1 is a block diagram illustrating an example system architecture in which implementations of the present disclosure may operate.

FIG. 2A is a block diagram illustrating an example cryptographic engine operating in accordance with some implementations of the present disclosure.

FIG. 2B is a diagram illustrating one example implementation of multiplication operations performed by the cryptographic engine 200, in accordance with some aspects of the present disclosure.

FIG. 2C is a diagram illustrating another example implementation of multiplication operations performed by the cryptographic engine, in accordance with some aspects of the present disclosure.

FIG. 3A illustrates schematically performance of a modular (or Montgomery) reduction during computations by the cryptographic engine, in accordance with some aspects of the present disclosure.

FIG. 3B illustrates schematically performance of modular (or Montgomery) reduction modulo simple primes during computations by the cryptographic engine, in accordance with some aspects of the present disclosure.

FIG. 4 is a block diagram illustrating a portion of a cryptographic engine that may perform efficient modular inversion and Jacobi symbol computation, in accordance with some implementations of the present disclosure.

FIG. 5 is a flow diagram depicting method of a streaming multiplication performed on a cryptographic processor that operates in accordance with one or more aspects of the present disclosure.

FIG. 6 is a flow diagram depicting another method of a streaming multiplication performed on a cryptographic processor that operates in accordance with one or more aspects of the present disclosure.

FIG. 7 is a flow diagram depicting method of determining results of certain modular operations using a cryptographic processor that operates in accordance with one or more aspects of the present disclosure.

FIG. 8 depicts a block diagram of an example computer system operating in accordance with one or more aspects of the present disclosure.

### DETAILED DESCRIPTION

Aspects of the present disclosure are directed to hardware cryptographic engines for improving computational efficiency and memory utilization in cryptographic operations that include, but are not limited to, public-key cryptography applications. More specifically, aspects of the present disclosure are directed to multi-lane cryptographic engines for efficient parallel and streaming processing of public key and private key operations, key generation, modular multiplication, Montgomery multiplication, modular inversion, Jacobi symbol computation, elliptic curve cryptographic operations, and numerous other cryptographic applications.

Various cryptographic applications may involve operations that are efficiently performed by offloading them from a main processor to a dedicated cryptographic engine (accelerator) that includes hardware circuits designed to improve speed and efficiency of arithmetic operations (multiplication, division, addition, etc.) and memory accesses. For example, in Rivest-Shamir-Adelman (RSA) public key/private key applications, large prime numbers p and q may be selected to generate a pair of a public (encryption) exponent e and a secret (decryption) exponent d such that e and d are inverse of each other modulo a certain number (e.g., modulo (p−1)·(q−1) or a lowest common multiplier of p−1 and q−1). The numbers e and N=p·q are revealed as part of the public key while p, q, and d are stored in secret as parts of the private key. A message m may be encrypted into a ciphertext c using modular exponentiation, c=m^{e} mod N, and can be deciphered using another modular exponentiation, m=c^{d} mod N, and based on the private exponent d. To prevent unauthorized actors from recovering the private exponent d, the prime multipliers p and q are typically selected to be large numbers, e.g., 1024-bit numbers.

Some applications use elliptic curve cryptography that involves operations with points (x,y) on an elliptic curve, e.g., an elliptic Weierstrass curve, y²=x³+ax+b. Arithmetic operations (such as addition, doubling, and infinity operations) are defined via a set of geometric rules; e.g., a sum of three points on an elliptic curve is zero, P₁+P₂+P₃=0, if the points P₁, P₂, P₃ are located at the intersection of the elliptic curve with a straight line. The strength of the elliptic curve cryptography is based on the fact that for large values of k, a product Q=P·k can be practically anywhere on the elliptic curve. As a result, the inverse operation to determine an unknown value of (e.g., private key) k from a known public value Q can be a prohibitively difficult computational operation. In elliptic curve cryptography, it is typically sufficient to use numbers that are much smaller (e.g., 256-bit numbers) than numbers used in RSA applications.

Decryption and encryption operations often require a large number of arithmetic operations to be performed, which may take many clock cycles, especially when performed on low-bit microprocessors, such as smart card readers, wireless sensor nodes, and so on. Cryptographic engines (accelerators, co-processors) are specially designed circuits that execute specialized computationally intensive cryptographic operations more efficiently than a general purpose processor (e.g., CPU). Because in many applications (including network and cloud applications) cryptographic operations may constitute a significant portion of the total computational load, small and efficient cryptographic engines are highly desired.

Described in the instant disclosure are cryptographic engines that allow a high degree of parallelism during performance of cryptographic computations. In some implementations, a cryptographic engine may include at least four multiplication circuits capable of operating synchronously on different inputs (e.g., different multiplicands and different multipliers) or streaming inputs. For example, a multiplier or multiplicand of a multiplication performed by a particular circuit may have previously been used in multiplication operations performed by preceding circuit (such that consecutive circuits compute increasingly more significant bits of the product). The cryptographic engine may further have two or more addition circuits similarly capable of operating synchronously with each other. The addition circuits may receive inputs from other addition circuits and/or multiplications circuits and may further provide outputs as inputs to any of the multiplication circuits. The cryptographic engine may include two or more memory devices, such as random access memory (RAM) units that permit one read or one write operation per cycle, scratchpad (SP) memory units that permit one read and one write operation per cycle, flip-flop memory, and the like. In some implementations, a co-processor may facilitate efficient performance of inverse multiplication, Jacobi symbol computations, and the like, by performing operations that are not reduced to multiplications and/or additions.

The disclosed cryptographic engine may be used for a wide range of cryptographic operations. Each multiplication and each addition circuit may, at a given cycle, process an N-bit operand. The size of the operand may be different in different implementations. For the sake of specificity, implementations disclosed herein will sometimes be illustrated using an example cryptographic accelerator that operates on N=64 bit operands, but it should be understood that circuits configured to process operands of any other size (e.g., N=8, 16, 32, 128, etc.) may also be used. During a cycle of computations, a word (to be understood as a group of, e.g., N bits) of a multiplier and a word of a multiplicand may be processed by one of the multiplication circuits. A low N-bit word of the output may be stored (e.g., in a SP memory) as the accumulator value and a high N-bit word may be stored as a carry (e.g., in a buffer, such as a flip-flop memory device). The accumulator and the carry may subsequently be used during processing of other words of the multiplier and multiplicand (some of which may be processed by the same multiplication circuit while other words may be processed by other circuits).

Multiplication (and addition) operations performed by the circuits of the cryptographic engine may be modular operations defined on a ring of p elements (e.g., elements belonging to the interval of integers [0, p−1]). Reduction modulo p may be performed by the circuits subsequently to the performance of multiplication. Because calculations modulo p require finding a remainder of a (computationally heavy) division operation, in some implementations a Montgomery reduction may be used. To find AB mod p, the multiplier A and the multiplicand B can first be transformed into the Montgomery domain, A mod p→Ā=AR mod p, B mod p→B̅=BR mod p, using an auxiliary modulus (Montgomery radix) R that is coprime with p and often chosen to have a simple form (e.g., a power of the base number). The number p(ĀB̅p′ mod R) is then added to the product ĀB̅ (without changing its value mod p). Provided that the number p′ is selected such that pp′+(R⁻¹mod p)·R=1, the sum ĀB̅+p(ĀB̅p′ mod R) is an integer number of radix R. Division by R is then easily performed (e.g., by bit shifting) with the result being a Montgomery representation C of the product C=AB mod p (or, if the result exceeds p, C is obtained by one additional subtraction of p). Using the Montgomery representation, any number of consecutive multiplications (and additions/subtractions) can be performed directly in the Montgomery domain with only the final output transferred back from the Montgomery domain (e.g., using one additional Montgomery reduction).

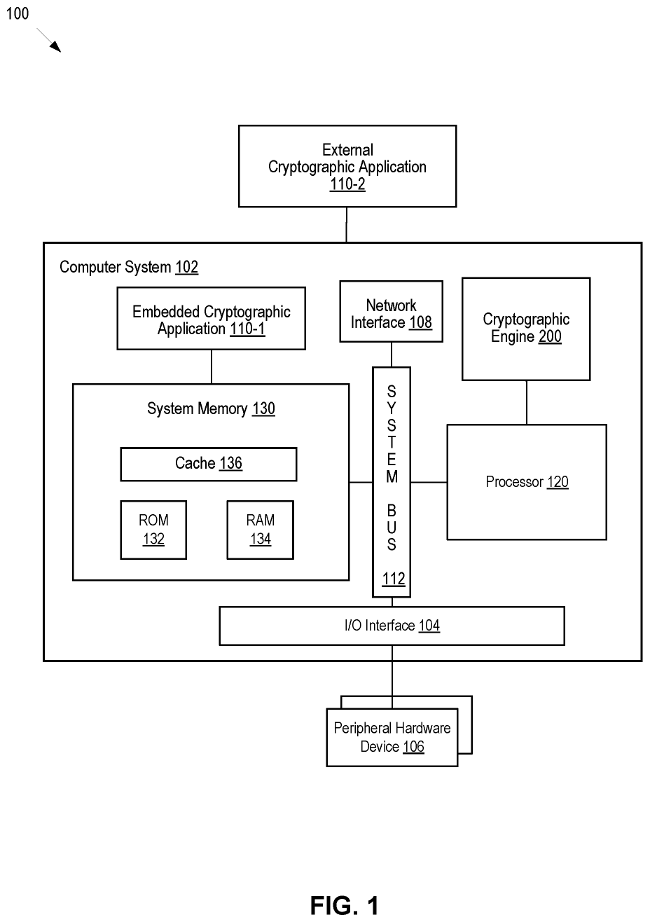

FIG. 1 is a block diagram illustrating an example system architecture 100 in which implementations of the present disclosure may operate. The example system architecture 100 may be a desktop computer, a tablet, a smartphone, a server (local or remote), a thin/lean client, and the like. The example system architecture 100 may be a smart a card reader, a wireless sensor node, an embedded system dedicated to one or more specific applications (e.g., cryptographic applications 110-1 and 110-2), and so on. The system architecture 100 may include, but need not be limited to, a computer system 102 having one or more processors 120, e.g., central processing units (CPUs), capable of executing binary instructions, and one or more memory devices 130. “Processor” refers to a device capable of executing instructions encoding arithmetic, logical, or I/O operations. In one illustrative example, a processor may follow Von Neumann architectural model and may include one or more arithmetic logic units (ALUs), a control unit, and a plurality of registers.

The system architecture 100 may further include an input/output (I/O) interface 104 to facilitate connection of the computer system 102 to peripheral hardware devices 106 such as card readers, terminals, printers, scanners, internet-of-things devices, and the like. The system architecture 100 may further include a network interface 108 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computer system 102. Various hardware components of the computer system 102 may be connected via a system bus 112 that may include its own logic circuits, e.g., a bus interface logic unit (not shown).

The computer system 102 may support one or more cryptographic applications 110-n, such as an embedded cryptographic application 110-1 and/or external cryptographic application 110-2. The cryptographic applications 110-n may be secure authentication applications, encrypting applications, decrypting applications, secure storage applications, and so on. The external cryptographic application 110-2 may be instantiated on the same computer system 102, e.g., by an operating system executed by the processor 120 and residing in the memory device 130. Alternatively, the external cryptographic application 110-2 may be instantiated by a guest operating system supported by a virtual machine monitor (hypervisor) executed by the processor 120. In some implementations, the external cryptographic application 110-2 may reside on a remote access client device or a remote server (not shown), with the computer system 102 providing cryptographic support for the client device and/or the remote server.

The processor 120 may include one or more processor cores having access to a single or multi-level cache and one or more hardware registers. In implementations, each processor core may execute instructions to run a number of hardware threads, also known as logical processors. Various logical processors (or processor cores) may be assigned to one or more cryptographic applications 110, although more than one processor core (or a logical processor) may be assigned to a single cryptographic application for parallel processing. A multi-core processor 120 may simultaneously execute multiple instructions. A single core processor 120 may typically execute one instruction at a time (or process a single pipeline of instructions). The processor 120 may be implemented as a single integrated circuit, two or more integrated circuits, or may be a component of a multi-chip module.

The memory device 130 may refer to a volatile or non-volatile memory and may include a read-only memory (ROM) 132, a random-access memory (RAM) 134, high-speed cache 136, as well as (not shown) electrically erasable programmable read-only memory (EEPROM), flash memory, flip-flop memory, or any other device capable of storing data. The RAM 134 may be a dynamic random-access memory (DRAM), synchronous DRAM (SDRAM), a static memory, such as static random-access memory (SRAM), and the like. Some of the cache 136 may be implemented as part of the hardware registers of the processor 120 In some implementations, the processor 120 and the memory device 130 may be implemented as a single field-programmable gate array (FPGA).

The computer system 102 may include a cryptographic engine 200 for fast and efficient performance of cryptographic computations, as described in more detail below. Cryptographic engine 200 may include processing and memory components, as described in more detail below. Cryptographic engine 200 may perform authentication of applications, users, access requests, in association with operations of the cryptographic applications 110-n or any other applications operating on or in conjunction with the computer system 102. Cryptographic engine 200 may further perform encryption and decryption of secret data.

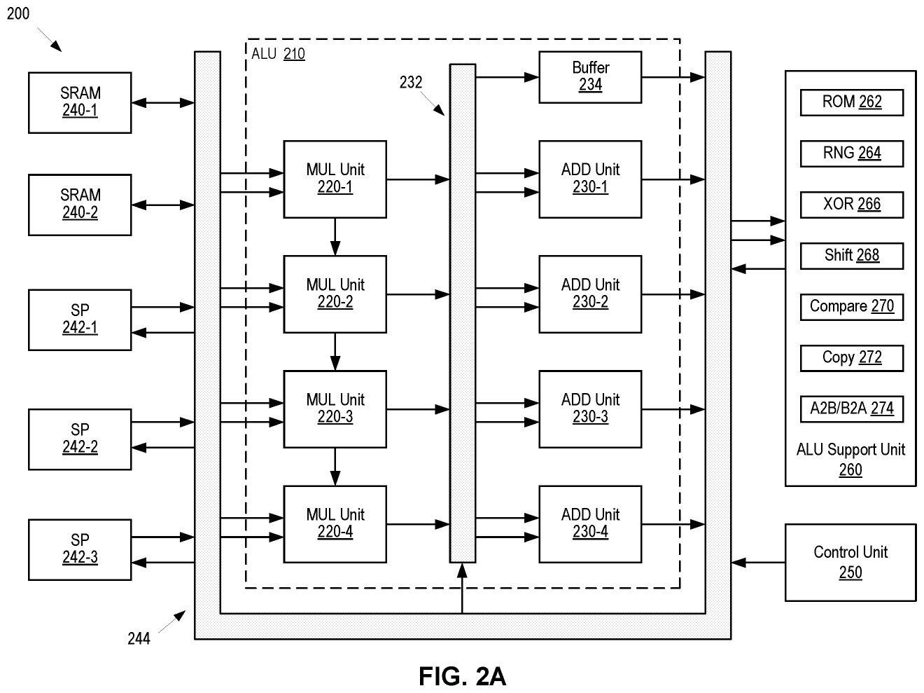

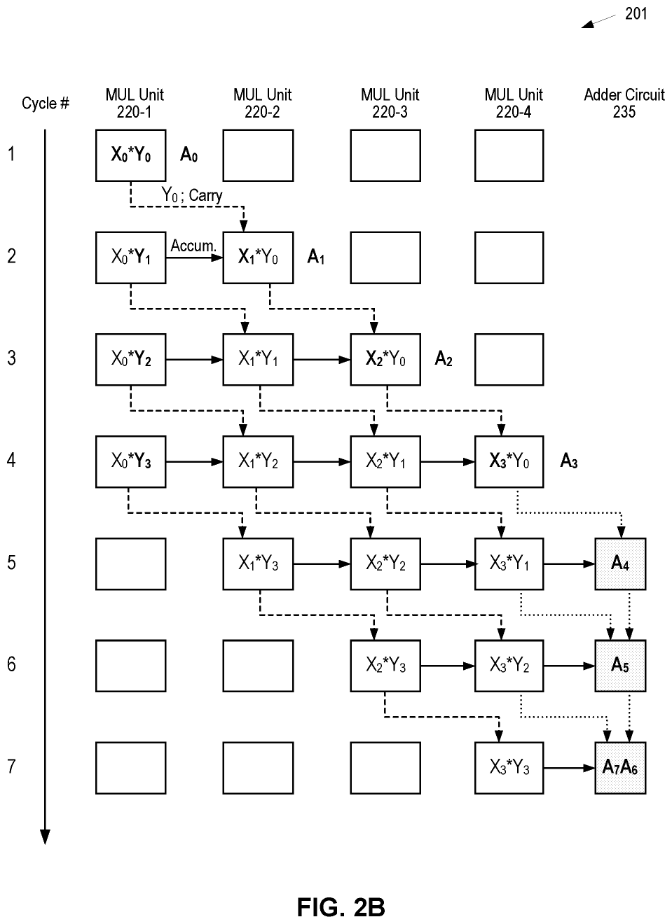

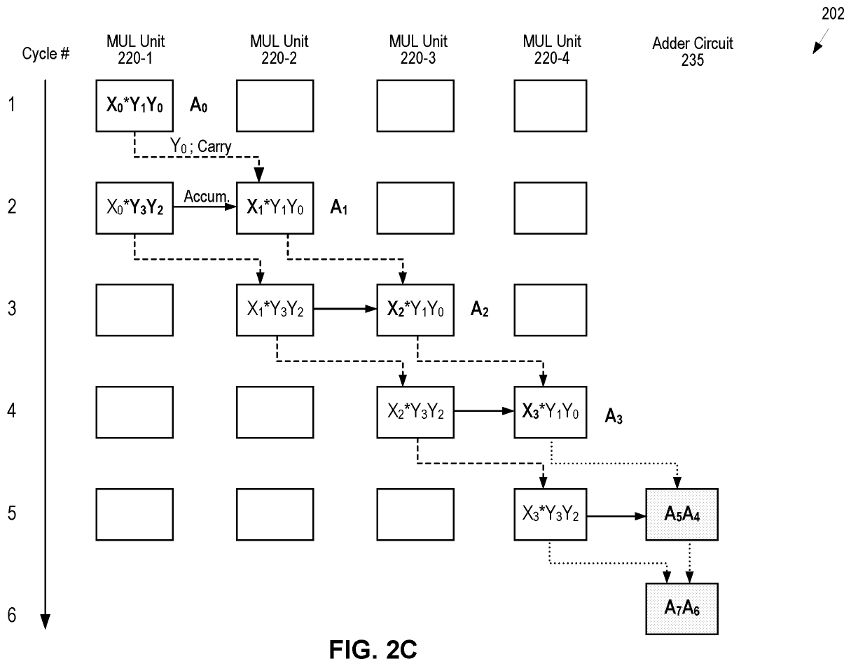

FIG. 2A is a block diagram illustrating an example cryptographic engine 200 operating in accordance with some implementations of the present disclosure. Cryptographic engine 200 may include an arithmetic logic unit (ALU) 210 having a number of multiplication (MUL) units 220-n. Shown are four MUL units 220-1 . . . 220-4 even though ALU 210 may include more than four MUL units. ALU 210 may also have a number of addition (ADD) units 230. Shown are four ADD units 230-1 . . . 230-4 even though in various implementation, ALU 210 may have two ADD units, three ADD units, or more than four ADD units. (Herein, the addition operations should also be understood to include subtraction operations, whenever applicable.) In some implementations, ALU 210 may further include a buffer 234 to store a number over a duration of a computational cycle. In some implementations, buffer 234 may have one input and may operate similarly to an addition circuit that adds zero to the input number. MUL units 220-n, ADD units 230-n, and buffer 234 may be connected to an ALU bus 232 that communicates data (e.g., input and output numbers) between any of MUL units 220-n and any of ADD units 230-n and/or buffer 234.

Cryptographic engine 200 may further include a number of memory circuits, such as static random-access memory (SRAM), e.g., SRAM 240-1 and 240-2, and scratchpad memory (SP), such as 242-1, 242-2, and 242-3. Even though two SRAM and three SP are shown in FIG. 2A, in implementations, any other number of memory circuits may be present. Each SRAM may be used to load one number (e.g., an N-bit word) or store one number per cycle (as indicated by bidirectional arrows associated with each SRAM). Each SP may be a two-port memory circuit that can be used to load one number and store one number per cycle (as indicated by two separate arrows associated with each SP). Each of MUL units 220-n, ADD units 230-n, buffer 234, SRAM 240-n, and SP 242-n may be connected to bus 244. Bus 244 may include a number of data communication lines (data bus) for transferring data (input and output numbers) between the aforementioned circuits. Additionally, bus 244 may include an address bus for communicating signals that identify source and destination of data. Bus 244 may also include a control bus, e.g., lines for communicating control signals from a control unit 250. Control unit 250 can include a clock to maintain cycles of computations and memory access operations. Control unit 250 may store instructions the cryptographic engine to perform various cryptographic computation. control unit 250 may be programmable, e.g., by an external processor, such as processor 120 of FIG. 1. In some implementations, processor 120 may executes one or more cryptographic applications 210-n and select a method of cryptographic protection to be used in connection with the executed cryptographic application(s). Methods of protection may include RSA algorithms, ECC algorithms, Data Encryption Standard (DES) algorithms, Advanced Encryption Standard (AES) algorithms, and so on. Processor 120 may select data to be encrypted or decrypted, identify cryptographic keys to be used, and so on. Processor 120 may provide instructions to control unit 250 to configure control unit 250 to provide cryptographic support for the application(s) executed by processor 120. Using instructions received from processor 120, control unit 250 may identify the type and the amount of operations to be performed by ALU 210, the size of the number to be multiplied, and so on. Control unit 250 may also fetch specific instructions (e.g., from memory of the cryptographic engine 200 or system memory 130) to support various operations to be performed by ALU 210.

Each of the MUL units 220-n and ADD units 230-n may be a circuit that operates on N-bit words (e.g., 64-bit inputs or inputs of any other suitable size) and may have at least two inputs (indicated by horizontal arrows). Additionally, MUL units 220-1 . . . 220-3 may stream outputs (as well as inputs, in some instances) of multiplications performed by the respective circuits as inputs into subsequent MUL units 220-2 . . . 220-4 (as depicted by the downward arrows). For example, an output of MUL unit 220-1 may be provided to the next MUL unit 220-2 or to the ALU bus 232. From ALU bus 232 the outputs of multiplications may be delivered to any of the ADD units 230-n (or buffer 234) or any of the memory circuits (SRAM 240-n or SP 242-n). In some instances, when an addition operation involves a number that is not an output of a previous multiplication operation, an input into an addition operation may be delivered via bus 244 from one of the memory circuits 240-n or 242-n (as depicted by the upward arrow between bus 244 and ALU bus 232).

An additional ALU support unit 260 may include circuits that perform operations different from multiplications or additions. ALU support unit 260 may include a read-only memory (ROM) 262, which may store constants (such as modulus p, Montgomery radix R, numbers p′, R⁻¹mod p, various other auxiliary numbers, such as powers of radix R, e.g., R₂ mod p or modulo some other suitable modulus), various instructions for control unit 250, and so on. ALU support unit 260 may further include a random number generator (RNG) 264 for generation of random (or pseudorandom) numbers, an XOR unit 266 for performing XOR operations, a shift unit 268 to perform bit shifting and bit masking, a compare unit 270 to perform comparison of input numbers, a copy unit 272 for copying numbers, an arithmetic-to-Boolean and/or Boolean-to-arithmetic conversion (A2B/B2A) unit 274. The A2B/B2A unit 274 may be used for handling keys and other secret data that is stored in masked Boolean or masked arithmetic form (e.g., as a plurality of randomized values whose Boolean or arithmetic sum, difference, etc. represents a secret value). For example, A2B/B2A unit 274 may convert data stored in a Boolean-masked form to an arithmetic-masked form (if a cryptographic application is configured to process data in the latter form), and/or vice versa. ALU support unit 260 may also include other auxiliary units (circuits) performing various functions that may be used in operations of cryptographic engine 200.

FIG. 2B is a diagram illustrating one example implementation of multiplication operations 201 performed by the cryptographic engine 200, in accordance with some aspects of the present disclosure. Depicted in FIG. 2B are multiplications performed by various MUL units 220-n during consecutive cycles of computations. The multiplication may involve multiplier X and/or multiplicand Y each having M words of N bits. For the sake of illustration, it shall be assumed that M=4 (although X and Y that have a different arbitrary number M of words may be multiplied similarly). The numbers will be shorthanded schematically as X=X₃X₂X₁X₀ (and, similarly, for Y) with X₀ denoting N least significant bits and X₃ denoting N most significant bits of X. In other words, X=X₀r⁰+X₁r¹+X₂r²+X₃r³, where r=2^{N} is the base number. The product

$$A = X \cdot Y = {X}_{0} {Y}_{0} {r}^{0} + ( {X}_{0} {Y}_{1} + {X}_{1} {Y}_{0} ) {r}^{1} + ( {X}_{0} {Y}_{2} + {X}_{1} {Y}_{1} + {X}_{2} {Y}_{0} ) {r}^{2} + ( {X}_{0} {Y}_{3} + {X}_{1} {Y}_{2} + {X}_{2} {Y}_{1} + {X}_{3} {Y}_{0} ) {r}^{3} + …$$

is, generally, a 2N-word number A=A₇ . . . . A₀. MUL units 220-n may be configured to perform multiplication on N-bit input numbers, e.g., 128-bit words of integer data or 256-bit words of integer data.

During cycle 1, MUL unit 220-1 may receive the low (least significant) word of multiplier X₀, and the low word of multiplicand, Y₀, and compute the product X₀·Y₀. The low word of X₀·Y₀ represents the low word A₀ of the product A and may be stored in one of memory circuits of the cryptographic engine 200 (or in an outside memory device). The high word of the product X₀·Y₀ may be stored in MUL unit 220-1 (e.g., in a flip-flop memory buffer associated with MUL unit 220-1) as a carry C into the operations of the next cycle. During (or prior to) cycle 2, MUL unit 220-1 may provide carry C and the low word of the multiplicand Y₀ to MUL unit 220-2, load the next word of the multiplicand Y₁ from memory, and multiply the previously loaded low word of the multiplier X₀ by the new word of the multiplicand Y₁. MUL unit 220-1 may then compute X₀·Y₁, buffer a new carry (the high word of X₀·Y₁) until the next cycle, and provide the accumulator value (the low word of X₀·Y₁) to MUL unit 220-2. The following notations are used in FIG. 2A to indicate the above described operations. The words that are loaded in conjunction with a respective multiplication operation are indicated with bolded letters inside the boxes and the multiplier/multiplicand words that are reused (passed between different multiplication units) are indicated with standard letters. Dashed lines indicate passage of 1) previously loaded words Yⱼ of the multiplicand and 2) previously computed carries. As encountered during later cycles, dotted lines indicate passage of previously computed carries (without passing the words of the multiplicand). Horizontal solid arrows depict passage of a (low word) accumulator value after computing a product indicated inside the respective box (where the solid arrow begins).

During cycle 2, MUL unit 220-2 may load the next word of the multiplier X₁ from the memory circuits, receive the low word of the multiplicand Y₀ from MUL unit 220-1 (as well as the respective carry), as depicted schematically with the dashed arrow, and may further receive the accumulator value computed by MUL 220-1 unit during the same cycle 2. MUL unit 220-2 may add the received carry and the accumulator to the product X₁·Y₀. MUL unit 220-2 may buffer the high word of the result as a carry (to be passed on to MUL unit 220-3 in cycle 3), and may store the low word A₁ as the next word of the product A. An addition unit, e.g., adder circuit 235 (or some other addition unit) may perform the addition operations described herein. In some implementations, the addition unit may be a multi-way addition circuit capable of adding more than two numbers per cycle; e.g., the addition unit may be capable of adding X₁·Y₀+carry+accumulator value in one operation. In some implementations, the addition unit may be configured to perform multiple consecutive additions of two numbers over one cycle (e.g., obtaining a first sum X₁·Y₀+carry during the first operation and then adding the accumulator value to the first sum during the second operation).

Similar computations may be performed in subsequent cycles. In cycle k, MUL 220-1 passes the multiplicand word Yₖ₋₂ (loaded during cycle k−1) and the carry (computed during the cycle k−1) to MUL 220-2 and loads the next multiplicand word Yₖ₋₁. Similarly, other multiplication units pass previously processed multiplicand words (and computed carries) to the next multiplication units. In addition, during cycle k≤M, MUL 220-k loads the multiplier word Xₖ₋₁ from memory and multiplies it by Y₀. During cycle k, different multiplication units compute products Xⱼ·Yₖ₋ⱼ₋₁ with different j. Accumulator values are passed from the respective multiplication units to the accumulator unit, e.g., adder circuit 235.

At the end of cycle k≤M, the word Aₖ₋₁ of the product A is determined (and stored in one of the memory circuits). At the end of cycle k=M+1, the low word of the result of multiplication X_{M-1}·Y₁ (plus received carry and accumulator value) is passed onto adder circuit 235, depicted via a shaded box, which adds the carry from the last block of cycle M (as depicted by the top dotted line). The low word of the sum represents the word A_{M} (e.g., A₄, as depicted) of the final product A and is stored in one of the memory circuits (e.g., together with previously computed words Aⱼ). The high word of the sum is retained in the adder (as depicted by the downward dotted arrow). At the end of each subsequent cycle, the adder adds a new carry (broken dotted line) and a new accumulator (solid arrow) to the previously stored high word, identifies the new low word as the next Aⱼ of the final product A, buffers the new carry, and so on. At the end of the last cycle k=2M−1 (after computing the last multiplication X_{M-1}·Y_{M-1}) both the high word and the low word of the last addition operation are stored as the last two words of the final product, A_{2M-1}A_{2M-2} (e.g., A₇A₆). As depicted in FIG. 2B with empty blocks, some of the multiplication units are idle during early cycles and also during late cycles. Idling units may be used to compute products of other numbers, in a pipelined fashion. For example, once MUL unit 220-1 becomes free (after cycle k=M is complete), MUL unit 220-1 is ready to load low words of additional multiplier and multiplicand (e.g., U₀ and V₀) that are to be multiplied. The process then continues for the new multiplier and multiplicand substantially as described above.

Each of MUL units 220-1 . . . 220-4 may include any number of processing elements (circuits), such as multiplication elements, addition elements, accumulator buffers, carry buffers, and the like. In some implementations, words X₀, X₁, . . . of the multiplier and words Y₀, Y₁, . . . of the multiplicand may be processed by respective MUL units 220-n in a systolic way. More specifically, each word may be subdivided into two or more sub-words and processed sequentially by two or more processing elements. For example, a 256-bit multiplier word X₀ may be subdivided into four 64-bit sub-words x₀₀, x₀₁, X₀₂, and x₀₃ with a first processing element of MUL unit 220-1 processing (e.g., multiplying, buffering, passing, and adding carry and accumulator values) the first sub-word x₀₀, a second processing element of MUL unit 220-1 processing the second sub-word x₀₁, and so on. Similarly, a 256-bit multiplicand word Y₀ may be subdivided into four 64-bit sub-words y₀₀, y₀₁, y₀₂, and y₀₃ with a first processing element of MUL unit 220-1 processing the first sub-word y₀₀ during a first part of cycle 1 (in the notations of FIG. 2B), processing the second sub-word y₀₁ during a second part of cycle 1, and so on. It should be understood that the above example of systolic processing is intended to be illustrative and not limiting, as in various implementations, MUL units 220-n may include a different number of processing elements (e.g., two, three, eight, etc.) and may be processing sub-words of different sizes (e.g., 32 bits, 128 bits, etc.). In some implementations, all sub-words of a given word may be loaded from memory (or obtained from a different MUL unit or ADD unit) at once. In some implementations, different sub-words of a given word may be loaded sequentially, e.g., one, two, or several sub-words per part of a given cycle.

Multiplication (and addition) units performing multiplication operations 201 illustrated in FIG. 2B multiply N-bit words of multiplier Xⱼ by N-bit words of multiplicand Yₖ (gear ratio 1:1). In some implementations, e.g., when the cryptographic engine 200 is used for Montgomery reduction, it may be efficient to perform multiplications using operands of unequal size, which is analogous to different gear ratios in a mechanical device. FIG. 2C is a diagram illustrating another example implementation of multiplication operations 202 performed by the cryptographic engine 200, in accordance with some aspects of the present disclosure. Depicted in FIG. 2C are multiplications that involve N-bit words of multiplier X and 2N-bit words of multiplicand Y (gear ratio 1:2). As depicted in FIG. 2C, during cycle 1, MUL unit 220-1 may receive the low word of multiplier, X₀, and two lowest words of multiplicand, Y₁Y₀. MUL unit 220-1 may then compute the product X₀·Y₁Y₀, which is (generally) a three-word number. The low word of X₀·Y₁Y₀ represents the low word A₀ of the product A and may be stored in one of memory circuits of the cryptographic engine 200 (or in an outside memory device). The two high word of the product X₀·Y₁Y₀ may be stored (buffered) in MUL unit 220-1 as a carry C into the operations of the next cycle.

During cycle 2, MUL unit 220-1 may provide carry C and the two low words of the multiplicand Y₁ Y₀ to MUL unit 220-2, load the next two words of the multiplicand Y₃Y₂, and multiply the previously loaded low word of the multiplier X₀ by the new words of the multiplicand Y₃ Y₂. MUL unit 220-1 may then compute X₀·Y₃Y₂, buffer a new carry (the high two words of X₀·Y₃Y₂) until the next cycle, and provide the accumulator value (the low word of X₀·Y₃Y₂) to MUL unit 220-2 (as indicated by the solid arrow). Additionally, during the same cycle 2, MUL unit 220-2 may load the next word of the multiplier X₁ from one of the memory circuits, receive the low two words of the multiplicand Y₁Y₀ from MUL unit 220-1 (as well as the respective carry), as depicted schematically with the dashed arrow. MUL unit 220-2 may further receive the accumulator value computed by MUL 220-1 unit during the same cycle 2. MUL unit 220-2 may add the received two-word carry and the one-word accumulator to the product X₁·Y₁Y₀. MUL unit 220-2 may buffer the two high words of the obtained result as a next carry (to be passed on to MUL unit 220-3 in cycle 3), and may store the low word A₁ as the next word of the product A.

Similar streaming computations may be performed in subsequent cycles, as depicted. In cycle k, MUL unit 220-1 passes the two multiplicand words Y₂ₖ₋₃Y₂ₖ₋₄ (loaded during cycle k−1) and the two-word carry (computed during cycle k−1) to MUL 220-2 and loads the next two multiplicand words Y₂ₖ₋₁Y₂ₖ₋₂. Similarly, other multiplication units pass previously processed multiplicand words (and computed carries) to the next multiplication units. In addition, during cycle k≤M, MULunit 220-k loads the multiplier word Xₖ₋₁ from memory and multiplies it by Y₁Y₀. During cycle k, products Xⱼ·Y₂ₖ₋₂ⱼ₋₁Y₂ₖ₋₂ⱼ₋₂ with different j are computed by different multiplication units. At the end of cycle k≤M, the word Aₖ₋₁ of the product A is determined (and stored in one of the memory circuits). At the end of cycle k=M+1, the low word of the result of multiplication X_{M-1}·Y₃Y₂ (plus the received carry and accumulator value) is passed onto an adder circuit 235), depicted via a shaded box, which adds the carry from the last block of cycle M (as depicted by the top dotted line). The adder circuit 235 may be a processing sub-unit that is internal to MUL unit 220-4 (or some other MUL unit). The low two words of the sum represent the words A_{M}A_{M-1} (e.g., A₅A₄ as depicted) of the final product A and are stored in one of the memory circuits (e.g., together with previously computed words Aⱼ). The high word of the sum is retained in the adder (the vertical dotted arrow). At the end of each subsequent cycle, the adder adds a new two-word carry (broken dotted line) and a new one-word accumulator (solid arrow) to the previously stored high word, identifies the new two low word as the next two words of the final product A and so on. After cycle M+1 (after computing the last multiplication X_{M-1}·Y_{M-1}Y_{M-2}) both the high word and the low word of the last addition operation are stored as the last two words of the final product, A_{2M-1}A_{2M-2} (e.g., A₇A₆). Similarly to FIG. 2B, the empty multiplication blocks indicate that pipelined processing of different pairs of multiplier/multiplicand may be performed while computation of X·Y is in progress.

In the example illustrated in FIG. 2C, 2N bits of multiplicand Y and N bits of multiplier X are loaded every cycle (until all bits of the multiplier and multiplicand are loaded). In some implementations, equal portions of each of the multiplier and multiplicand may be loaded. For example, while 2N bits of multiplicand Y may be loaded every cycle, the same number of 2N bits of multiplier X may be loaded every odd cycle. More specifically, during cycle 1, N-bit word X₀ of the multiplier is loaded into MUL unit 220-1 and another N-bit word X₁ of the multiplier is loaded into MUL unit 220-2 (where it remains unused until cycle 2). Similarly, during cycle 3, N-bit word X₂ of the multiplier is loaded into MUL unit 220-3 and another N-bit word X₄ of the multiplier is loaded into MUL unit 220-4 (where it remains unused until cycle 4).

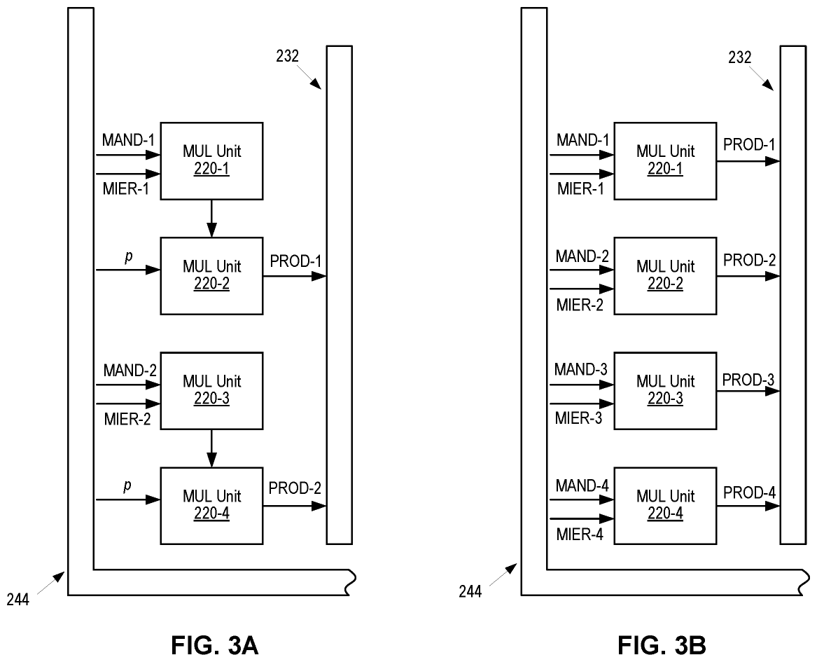

Referring back to FIG. 2A, any or all MUL units 220-n may perform modular multiplications and any or all ADD units 230-n may perform modular addition (or subtraction). In some implementations, modular reduction may be performed as the Montgomery reduction. In some implementations, modular or Montgomery reduction may be performed on successive words of the output Aⱼ without first storing the output words in memory. FIG. 3A illustrates schematically performance of a modular (or Montgomery) reduction during computations by the cryptographic engine 200, in accordance with some aspects of the present disclosure. As depicted in FIG. 3A, MUL unit 220-1 may receive (from memory and/or from any of the ADD units 230-n) a word of multiplicand (MAND-1) and a word of multiplier (MIER-1) and perform regular (non-modular) multiplication. After the multiplication is performed, the product is not output to ALU bus 232 (for storage in one of the memory circuits) but is instead streamed to the next MUL unit 220-2 for a modular (or Montgomery) reduction. As depicted schematically by a solid arrow, the input into MUL unit 220-2 may include the modulus p (and/or various auxiliary numbers used in Montgomery reduction). In some implementations, the modulus p (and/or the auxiliary numbers) may be pre-loaded into MUL unit 220-2 (e.g., stored in a buffer memory of MUL unit 220-2). The output (PROD-1) of MUL unit 220-2 is the modular-reduced word Aⱼ output during the preceding cycle by MUL unit 220-1. As further depicted in FIG. 3A, a pair of MUL unit 220-3 and MUL unit 220-4 may similarly be determining and reducing another number (PROD-2), which may be a product of a different word of multiplicand (MAND-2) and a different word of multiplier (MIER-2).

In some instances, modular (or Montgomery) reduction may be performed by the same multiplication unit that computes the original product, e.g., when a special prime modulus p is being used, such as one of Solinas primes (e.g., p=2¹⁹²−2⁶⁴−1, p=2³⁸⁴−2¹²⁸−2⁹⁶+2³²−1), Mersenne primes, Crandall primes, and other simple primes. FIG. 3B illustrates schematically performance of modular (or Montgomery) reduction modulo simple primes during computations by the cryptographic engine 200, in accordance with some aspects of the present disclosure. As depicted in FIG. 3B, each MUL unit 220-n may be multiplying a different word of multiplicand (MAND-n) and multiplier (MIER-n), reducing a product, and outputting the respective reduced product (PROD-n) to ALU bus 232 without streaming the intermediate output to the next multiplication unit.

In some implementations, the cryptographic engine 200 is used for elliptic curve cryptographic (ECC) computations with Weierstrass curves, Brainpool curves, NIST curves, etc. ECC computations may involve multiplying a number represented by a base point P on an elliptic curve by a large number k (e.g., a private key). Finding the product P·k may be performed efficiently using one of the available ladder algorithms, such as the Montgomery ladder algorithm, the double-and-add algorithm, the Joye ladder algorithm, windowed algorithms, non-adjacent form algorithms, or any other suitable algorithms. These algorithms are executed by performing a number (of the order of log₂ k) iterations by keeping track of working points, e.g., X₁ and X₂, and defining a set of conditional (upon a value of the next bit of the key k) rules that manipulate the working points. The manipulations may include (depending on a specific algorithm being used) one or more of: adding the working points X₁ and X₂, doubling one of the working points X₁ or X₂ while keeping the other working point intact, doubling one of the working points and then adding the other working point, etc., until (at the completion of the algorithm) one of the working points provides a representation of the target product P·k.

Each ladder algorithm may specify how coordinates of the working points change with each ladder step. In various implementations, coordinates can be scaled Jacobi coordinates. In some implementations, the algorithms track one or more auxiliary variables, such as a slope of the line associated with one or more of the working points, and so on. Each step may involve a number of operations (multiplications and additions) to update all (e.g., four or five) values being tracked. Cryptographic engine 200 of FIG. 2A may perform such operations in parallel, by performing a number (e.g., three or four) of multiplication operations, followed by a number (e.g., three or four) addition operations, followed again by a new number of multiplication operations, and so on. In some instances, each working point (or auxiliary number) may be represented by a 256-bit number, each split into four N=64 bit words and processed in a streaming fashion, as described above in conjunction with FIG. 2B and/or FIG. 2C. As described above, processing of different numbers may be performed using a pipeline, with the processing of words of a subsequent number beginning prior to completion of the computations of the previous number.

The cryptographic engine 200 may also be used for modular inversion, namely for computing an inverse of one number x modulo another number y: z=x⁻¹ mod y. The inverse number z multiplied by x equals 1, up to an integer multiple of y: z·x=1+s·y. According to the extended Euclidean algorithm, a two-component vector made of x and y may be expressed via a 2×2 matrix \hat{M} whose determinant is −1:

$$( \begin{matrix}y \\ x\end{matrix} ) = \hat{M} \cdot ( \begin{matrix}1 \\ 0\end{matrix} ) ≡ ( \begin{matrix}y & z \\ x & s\end{matrix} ) \cdot ( \begin{matrix}1 \\ 0\end{matrix} ) .$$

The off-diagonal element of the matrix then gives the target inverse number, \hat{M}₁₂=x⁻¹ mod y. The matrix M may be determined iteratively, by dividing y by x and identifying the quotient q₀ and the remainder x₁,

$$y = {q}_{0} \cdot x + {x}_{1} ,$$

which may be, equivalently, expressed in matrix form:

$$( \begin{matrix}y \\ x\end{matrix} ) = {\hat{M}}_{1} \cdot ( \begin{matrix}x \\ {x}_{1}\end{matrix} ) ≡ ( \begin{matrix}{q}_{0} & 1 \\ 1 & 0\end{matrix} ) \cdot ( \begin{matrix}x \\ {x}_{1}\end{matrix} ) ,$$

via step matrix \hat{M}₁. The process is continued by further dividing x by x₁ and finding a new quotient qⱼ and a new remainder xⱼ, so that during j-th iteration: xⱼ₋₂=qⱼ₋₁·xⱼ₋₁+xⱼ₋₂, or in matrix form (with x₀≡x),

$$( \begin{matrix}{x}_{j - 2} \\ {x}_{j - 1}\end{matrix} ) = {\hat{M}}_{j} \cdot ( \begin{matrix}{x}_{j - 1} \\ {x}_{j}\end{matrix} ) ≡ ( \begin{matrix}{q}_{j - 1} & 1 \\ 1 & 0\end{matrix} ) \cdot ( \begin{matrix}{x}_{j - 1} \\ {x}_{j}\end{matrix} ) , j > 1.$$

The iterations stop when during a final (n-th) iteration it is determined that xₙ₋₂ is divisible by xₙ₋₁ (xₙ₋₂=qₙ₋₁·xₙ₋₁); the inverse number is then given by the off-diagonal matrix element of the product of all identified step matrices:

$${x}^{- 1} mod y = {( - 1 )}^{n} {( {\prod }_{j = 1}^{n} {\hat{M}}_{j} )}_{12} .$$

The binary Euclidean algorithm determines a greatest common divisor (GCD) of two numbers, x and y, while avoiding division operations (other than division by 2 or powers of 2, which may be performed by bit shifting). More specifically, if x and y are both even, GCD(x,y)=2·GCD(x/2,y/2). If x is even and y is odd, GCD(x,y)=GCD(x/2,y). If both x and y are odd, GCD(x, y)=GCD (|x−y|, min (x, y)). By iteratively repeating these steps, the numbers are progressively reduced until one of the numbers is zero, e.g., x=0, and the GCD is given by the other number, e.g., GCD (0, y)=y.

Cryptographic engine 200 may perform matrix multiplication as described above, with four MUL units 220-n computing matrix elements of the product \hat{M}ⱼ·\hat{M}ⱼ₋₁ in a parallel or streaming fashion. For example, the cryptographic engine 200 may first compute the first column of the product \hat{M}ⱼ·\hat{M}ⱼ₋₁, e.g., (\hat{M}ⱼ·\hat{M}ⱼ₋₁)₁₁=(\hat{M}ⱼ)₁₁(\hat{M}ⱼ₋₁)₁₁+(\hat{M}ⱼ)₁₂(\hat{M}ⱼ₋₁)₂₁ and (\hat{M}ⱼ·\hat{M}ⱼ₋₁)₂₁=(\hat{M}ⱼ)₂₁(\hat{M}ⱼ₋₁)₁₁+(\hat{M}ⱼ)₂₂(\hat{M}ⱼ₋₁)₂₁, using four MUL units 220-1 . . . 220-4 and store the computed matrix elements (e.g., in SRAM 240-1, 240-2, and/or SP 242-1, 242-1, etc.). If the cryptographic engine has more than four MUL units, then the matrix elements of the second column of the product \hat{M}ⱼ·\hat{M}ⱼ₋₁ may be computed in parallel in a similar manner; otherwise, the matrix elements may be computed over several cycles. The stored matrix elements are then used in subsequent iterations of product Πⱼ₌₁ⁿ \hat{M}ⱼ computations. In some implementations, the size of the matrix elements may exceed the size of the operands of MUL units 220-n. In such implementations, the products, e.g., (\hat{M}ⱼ)₁₁(\hat{M}ⱼ₋₁)₁₁ may be computed in a streaming fashion with a first portion of a multiplicand, e.g., (\hat{M}ⱼ)₁₁, handled by MUL unit 220-1 and a second portion of the multiplicand handled by MUL unit 220-2, with portions of a multiplier, e.g., (\hat{M}ⱼ₋₁)₁₁, streamed through both MUL units 220-1 and 220-2. Similarly, the product (\hat{M}ⱼ)₁₂(\hat{M}ⱼ₋₁)₂₁ may be computed by MUL units 220-3 and 220-4. Accordingly, computation of matrix element (\hat{M}ⱼ·\hat{M}ⱼ₋₁), may take several cycles of cryptographic engine 200 with matrix element (\hat{M}ⱼ·\hat{M}ⱼ₋₁)₂₁ computed during the following several cycles. In some implementations, even when the size of the matrix elements does not exceed the size of the operands of MUL units 220-n, computations of the products, e.g., (\hat{M}ⱼ)₁₁(\hat{M}ⱼ₋₁)₁₁, may still be performed by two MUL units 220-n, with one MUL unit computing the corresponding product, and the next MUL unit performing Montgomery modular reduction of the computed product.

The cryptographic engine 200 can also be used for computation of Jacobi (and Legendre) symbols. A Legendre symbol

$${( \begin{matrix}x \\ y\end{matrix} )}_{L}$$

indicates whether x is a quadratic residue modulo prime number y; namely, the Legendre symbol

$${( \begin{matrix}x \\ y\end{matrix} )}_{L}$$

is +1 if there exists a number z whose square modulo y is equal to x: z²=x mod y. The Legendre symbol is −1 if no such number z exists (and the Legendre symbol is 0 if x is divisible by y). The Jacobi symbol

$${( \frac{x}{y} )}_{J}$$

extends the definition of the Legendre symbol to non-prime numbers y and amounts to a product of Legendre symbols for all prime factors of y. The Jacobi and Legendre symbols are frequently used in cryptographic applications, e.g., for generation (and primality testing) of prime number candidates. A quadratic reciprocity theorem expresses a Jacobi symbol

$${( \frac{x}{y} )}_{J}$$

via its swapped counterpart

$${( \frac{y mod x}{x} )}_{J} .$$

Because, by definition, y mod x<x, such swapping results in a Jacobi symbol having smaller arguments. Repeating the swapping operation until the top number is 0 or 1 (1 is a quadratic residue modulo any number), and using known rules for the change of sign of the Jacobi symbol during each swapping, the value of the target Jacobi symbol

$${( \frac{x}{y} )}_{J}$$

may be determined.

The above method of computing the Jacobi symbol using the quadratic reciprocity leads to a large number of subtraction and swapping operations. Alternatively, the binary Euclidean algorithm (similar to the one used to find a greatest common divisor of two numbers) may be used, which amounts to a set of the following rules. If x is even, it can be replaced x→x/2, with the ensuing symbol

$${( \frac{x / 2}{y} )}_{J}$$

to be multiplied by an appropriate factor (more specifically, (−1)^{(y}^{²}^{-1)/8}). If x<y, the Jacobi symbol is swapped, as described above; and if y is odd, it can be replaced with y mod x. This iterative transformation of the Jacobi symbol to symbols with smaller numbers can be performed on the cryptographic engine 200 using matrix multiplication to compute a set of new numbers

$$( \begin{matrix}x \\ y\end{matrix} ) = {\hat{M}}_{1} \cdot ( \begin{matrix}{x}_{1} \\ {y}_{1}\end{matrix} ) ,$$

with the vector

$$( \begin{matrix}{x}_{1} \\ {y}_{1}\end{matrix} )$$

denoting the iterated

$${( \frac{x}{y} )}_{J}$$

Jacobi symbol. The computation of the total transformation matrix can be performed on the cryptographic engine as a product of multiple step matrices \hat{M}ⱼ, using the streaming processing, as described above in relation to the modular inversion.

Computation of the Jacobi symbols using the binary Euclidean algorithm involves a substantial number of subtraction and swapping operations. Additionally, while division by 2 and subtraction of the denominator from the numerator may be performed in a streaming fashion, with low-words of the numerator and the denominator processed before the high words, the swapping operation depends on which number, x or y, is greater than the other number, which depends on the highest non-zero word of each number. To avoid delaying computations until the highest words are determined, in some implementations, cryptographic engine 200 may compute the Jacobi symbol(s) using a method that exploits some concepts of the 2019 Bernstein-Yang algorithm for modular inversion. More specifically, the numerical comparisons of x and y may be replaced with a uniformity tracker δ that indicates a degree of uniformity to which matrix \hat{M}ⱼ is reducing the numbers x and y.

The uniformity tracker & starts at initial value of zero and its absolute value |δ| increases or decreases in increments of one, per iteration. If the numerator x is even, the uniformity tracker δ is incremented by one while the numerator is halved:

$$\begin{matrix}{δ}^{′} = δ + 1 , & {x}^{′} = \frac{x}{2} , & {y}^{′} = y\end{matrix} . \qquad ( Case 1 )$$

If the numerator x is odd, the update step depends on the sign of the uniformity tracker δ. If the uniformity tracker δ is negative or zero, δ≤0, the uniformity tracker δ is incremented by one while the numerator is replaced with the mean of the numerator x and the denominator y:

$$\begin{matrix}{δ}^{′} = δ + 1 , & {x}^{′} = \frac{x + y}{2} , & {y}^{′} = y\end{matrix} . \qquad ( Case 2 )$$

or in matrix form

$$( \begin{matrix}{y}^{′} \\ {x}^{′}\end{matrix} ) = {\hat{M}}_{1} \cdot ( \begin{matrix}y \\ x\end{matrix} ) ≡ ( \begin{matrix}1 / 2 & 1 / 2 \\ 0 & 1\end{matrix} ) \cdot ( \begin{matrix}y \\ x\end{matrix} ) .$$

If the uniformity tracker δ is positive, δ>0, the uniformity tracker δ is decremented by one and the sign of the ensuing value is reversed, the Jacobi symbol is swapped, and the new denominator is one half of the difference of the old denominator and the old numerator:

$$\begin{matrix}{δ}^{′} = 1 - δ , & {x}^{′} = \frac{y - x}{2} , & {y}^{′} = x\end{matrix} , \qquad ( Case 3 )$$

or in matrix form

$$( \begin{matrix}{y}^{′} \\ {x}^{′}\end{matrix} ) = {\hat{M}}^{- 1} \cdot ( \begin{matrix}y \\ x\end{matrix} ) ≡ ( \begin{matrix}- 1 / 2 & 1 / 2 \\ 1 & 0\end{matrix} ) \cdot ( \begin{matrix}y \\ x\end{matrix} ) .$$

In addition to the change of numbers, as expressed by the latter rule, the Jacobi symbol flips its sign when y′>0 and x′<0. (There is no additional sign flipping when x is even or when the uniformity tracker δ is negative.) Case 3 may be visualized as a 90-degree rotation in the xy-plane: x→y, y→−x followed by the Case 2 transformation. The number of times the sign of the Jacobi symbol is to be flipped is determined by the number of times the element (\hat{M}⁻¹)₁₁ of the transformation matrix has changed signs, which may be tracked by setting a sign counter. Because the Jacobi symbol is periodic with the value of the counter modulo 4, a counter may be a 2-bit counter. The counter may additionally track the number of times (a current) value y (y′, etc.) has changed signs and add this number of times to the value stored in the counter.

Bernstein and Yang observed that k first steps of computations of the matrix \hat{M}_{1 . . . k}: =Πⱼ₌₁^{k} \hat{M}ⱼ may be performed based on k least significant bits of the numbers x and y. For example, k=32 (or some other number) first steps of computation of the matrix \hat{M}_{1 . . . k} may be performed before the computed matrix is applied to x and y. The numbers x and y may then be updated by multiplication of \hat{M}_{1 . . . k}, thus obtaining x′ and y′. The same procedure may be then repeated starting with updated x′ and y′. Such an iterative procedure may be performed on the cryptographic engine 200 using input data streaming, as described above in conjunction with FIG. 2B and FIG. 2C.

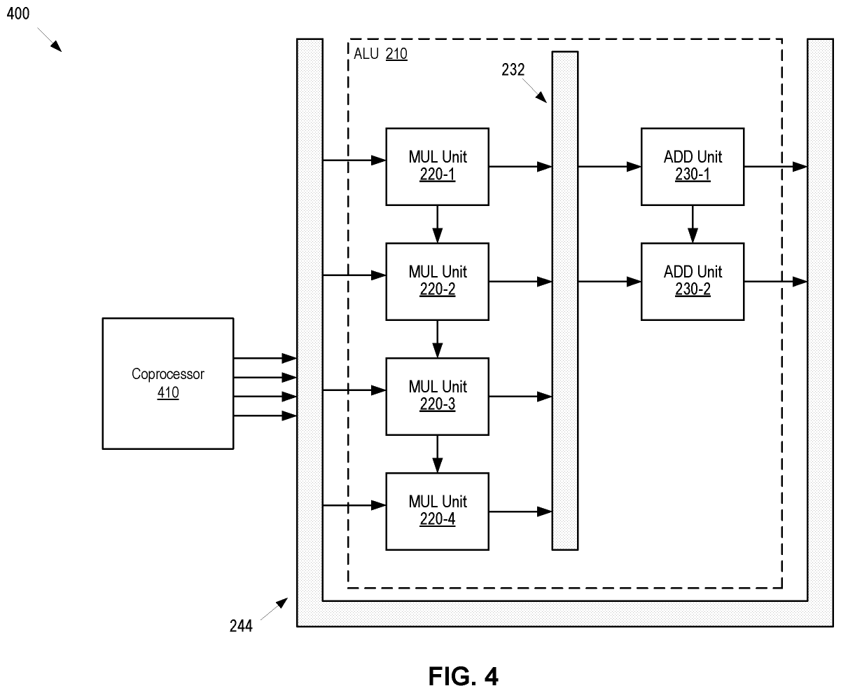

FIG. 4 is a block diagram illustrating a portion 400 of a cryptographic engine that may perform efficient modular inversion and Jacobi symbol computation, in accordance with some implementations of the present disclosure. The cryptographic engine illustrated in FIG. 4 may be the cryptographic engine 200 of FIG. 2A that further includes a co-processor 410. The co-processor 410 may load at least a first k (e.g. k+2) bits of each of the numbers x and y, compute coefficients of the step matrices M; and perform matrix multiplication of the step matrices to determine the (k+1)-bit batch matrix \hat{M}_{1 . . . k} using streaming computations, as described above. The co-processor 410 may compute the batch matrix \hat{M}_{1 . . . k} using a first word of the matrix elements of the first column of the step matrices \hat{M}ⱼ (provided that k does not exceed the size of the word). The batch matrix may be computed iteratively, starting with the identity matrix.

In some implementations, the co-processor 410 may use the least significant bit (LSB) of x and the LSB of y and compute a step matrix \hat{M}₁ and apply the matrix \hat{M}₁ to x and y, and to the current value of the batch matrix. This process may be repeated k times. In some implementations, the co-processor 410 may use the two LSB of x and computes a double-step matrix \hat{M}₂·\hat{M}₁, e.g., using a look-up table, and applies the double-step matrix to x and y, and to the current value of the batch matrix. This process may be repeated k/2 times, at each iteration building the batch matrix by multiplying it by an additional (single or double) step matrix. Also, during each of k (or k/2) iterations, the co-processor 410 may use the next most significant bits of x and y (e.g., 3 or 4 bits in total) to determine whether the transformations used change the sign of the Jacobi symbol, and/or whether element 11 of the transformation matrix and/or y has become negative. The co-processor 410 may then update the sign counter (e.g., a 2-bit sign counter, as described above).

At the completion of k (or k/2) iterations, the co-processor 410 may provide the computed coefficients of the batch matrix \hat{M}_{1 . . . k} to ALU 210 (e.g. MUL units 220-n) which may apply the batch matrix to the numbers x and y to obtain the updated numbers, e.g., x′ and y′. Subsequently, the co-processor 410 may compute the next batch of step matrices, e.g., \hat{M}_{k+1 . . . 2k}. The next batch may be computed in parallel with ALU 210 applying batch \hat{M}_{1 . . . k}, and so on. When k+2 LSB of updated numbers x′ and y′ have become available, ALU 210 may provide these bits to the co-processor 410 and the co-processor 410 may begin computations of the next batch of step matrices, \hat{M}_{k+1 . . . 2k}. When the sign of y becomes available, ALU 210 may provide the sign of y to the co-processor 410 and the co-processor 410 may update the sign counter, if indicated by the sign. At the conclusion of all iterations, the Jacobi symbol may be read from the sign counter of the co-processor 410, whereas a greatest common divisor (GCD) of x and y, as well as modular inverse y mod x, are stored (as different elements of matrix \hat{M}⁻¹) in memory circuits of ALU 210. In the instances where GCD is greater than 1, the Jacobi symbol is zero; otherwise the Jacobi symbol is given by the value in the sign counter.

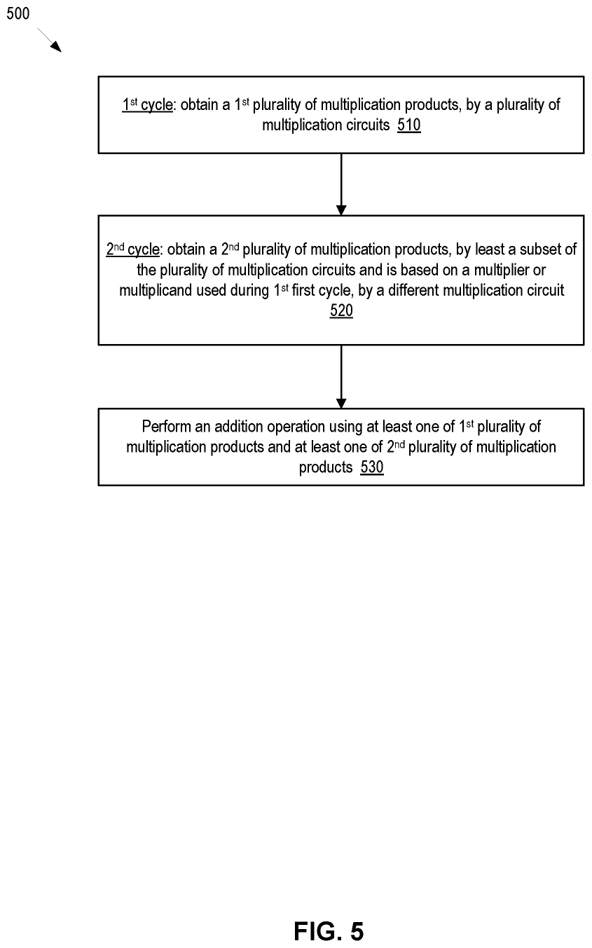

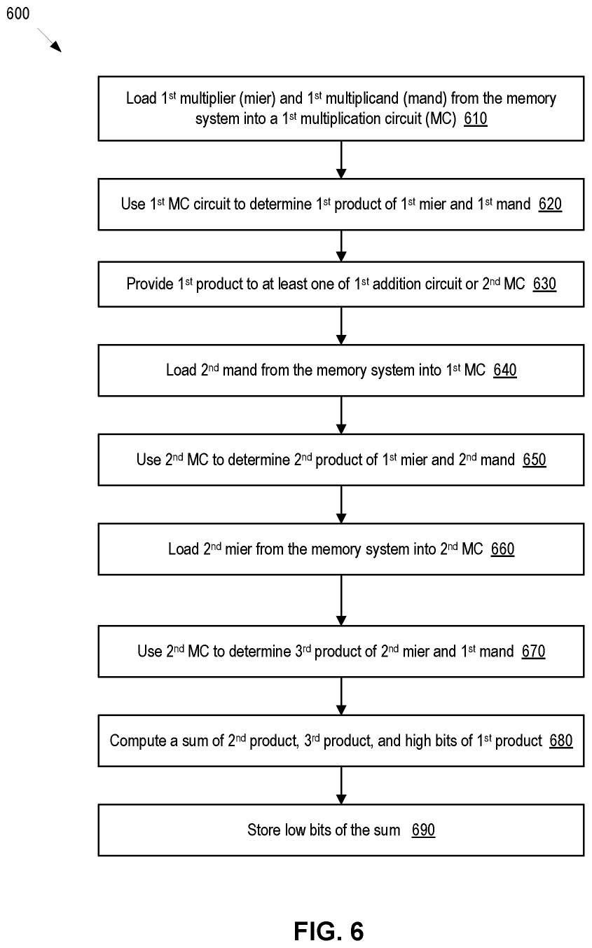

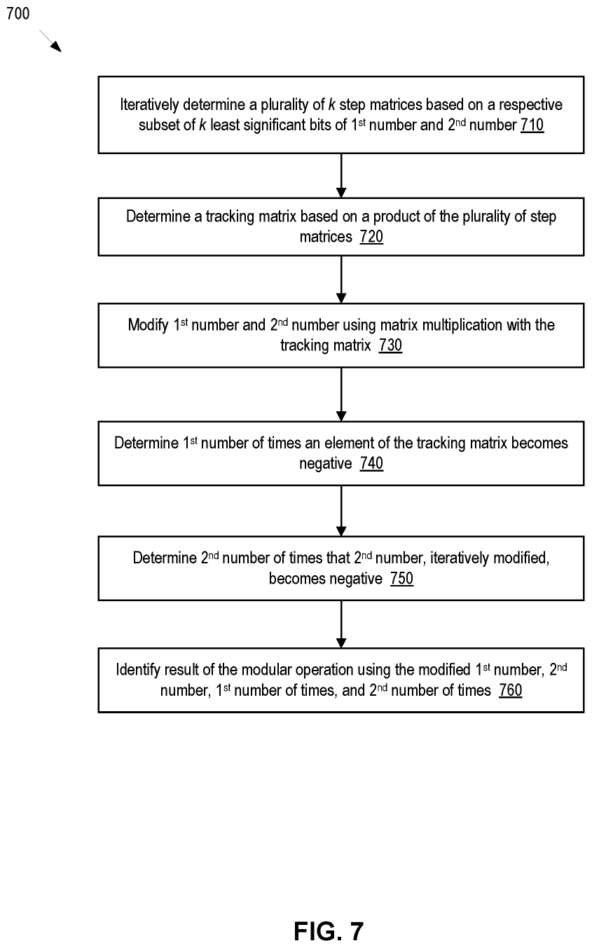

FIG. 5, FIG. 6, and FIG. 7 are flow diagrams depicting illustrative methods 500, 600, and 700 of using a cryptographic engine that operates in accordance with one or more aspects of the present disclosure. Methods 500, 600, and 700 and/or each of their individual functions, routines, subroutines, or operations may be performed by a cryptographic processor (accelerator), such as cryptographic engine 200 depicted in FIG. 2A. Various blocks of methods 500, 600, and 700 may be performed in a different order compared with the order shown in FIG. 5, FIG. 6, and FIG. 7. Some blocks may be performed concurrently with other blocks. Some blocks may be optional. Methods 500, 600, and 700 may be implemented as part of a cryptographic operation, which may involve a public key number and a private key number. The cryptographic operation may include RSA algorithm, an elliptic curve-based computation, or any other suitable operation.

A cryptographic processor that performs methods 500, 600, and 700 may include a plurality of four or more multiplication circuits (e.g., MUL units 220-n). The cryptographic processor may further include a plurality of two or more addition circuits (e.g., ADD units 230-n). Each of the plurality of the addition circuits may be communicatively coupled (e.g., via one or more buses) to at least one of the multiplication circuits. In some implementations, each of the plurality of the addition circuits is coupled to all multiplication circuits. In some implementations, some or all of the multiplication circuits may be configured to perform modular multiplication and some or all of the addition circuits may be configured to perform modular addition. In some implementations, some or all of the multiplication circuits may be configured to perform Montgomery multiplication.

The cryptographic processor may further include a memory system having two or more memory units. Each of the memory units may be communicatively coupled to at least one of the multiplication circuits and at least one of the addition circuits. One or more of the memory units may be double-port memory units capable of performing a read operation and a write operation within a same cycle of cryptographic processor operations.

FIG. 5 is a flow diagram depicting method 500 of a streaming multiplication performed on a cryptographic processor that operates in accordance with one or more aspects of the present disclosure. At block 510, the cryptographic processor performing method 500 may obtain, during a first cycle, a first plurality of multiplication products. Each of the first plurality of multiplication products may be obtained by a respective one of the plurality of multiplication circuits. At least some of the first plurality of multiplication products may be obtained using multipliers and multiplicands loaded from the memory circuits. The terms “first” and “second,” as used herein, should be understood as mere identifiers and may refer to any cycles of operations of the cryptographic processor. In some implementations, multipliers and multiplicands may be multiple-precision numbers, such as 128-bit numbers, 256-bit numbers, and so on. In some implementations, each of the multiplication circuits may be further subdivided into two or more processing units configured to handle smaller portions of the multiplier and multiplicand numbers (e.g., 64-bit portions, 32-bit portions, etc.).

At block 520, the cryptographic processor may, during a second cycle, obtain a second plurality of multiplication products. Each of the second plurality of multiplication products may be obtained by a respective multiplication circuit of at least a subset of the plurality of multiplication circuits and may be based on a multiplier or a multiplicand used, during the first cycle, by a different multiplication circuit. For example, with reference to FIG. 2B, during cycle 2 (“first cycle”), the plurality of MUL units 220-n may compute a first plurality of multiplication products, e.g., X₀. Y₃Y₂ and X₁·Y₁Y₀, with computations being performed by MUL units 220-1 and 220-2 while MUL units 220-3 and 220-4 remain idle (or perform operations related to a previous pipelined computation). During cycle 3 (“second cycle”), the plurality of MUL units 220-n may compute a second plurality of multiplication products, e.g., X₁·Y₃ Y₂ and X₂·Y₁Y₀, with computations performed by MUL units 220-2 and 220-3 while MUL units 220-1 and 220-4 remain idle (or perform operations related to a subsequent and a previous pipelined computations, respectively). A subset of the multiplication units (e.g., MUL units 220-2 and 220-3) may perform multiplications using multiplicands (e.g., Y₃ Y₂ and Y₁Y₀, respectively) that were used, during cycle 2, by a different multiplication circuit (e.g., by MUL units 220-1 and 220-2, respectively).

At least some of the first plurality of multiplication products or the second plurality of multiplication products may be obtained using multipliers loaded from the memory circuits. For example, during cycle 2, multiplier X₁ and multiplicand Y₃Y₂ may be loaded from the memory circuits (while multiplier X₀ is loaded during a previous cycle and multiplicand Y₁Y₀ is passed from MUL unit 220-1 to MUL unit 220-2). Similarly, during cycle 3, multiplier X₂ may be loaded from one of the memory circuits.

At block 530, the cryptographic processor may use at least one of the plurality of addition circuits to perform an addition operation using at least one of the first plurality of multiplication products and at least one of the second plurality of multiplication products. For example, with reference to FIG. 2B, after cycle 3 (or as part of cycle 3), adder circuit 235 (or some other addition or accumulation circuit) may add a carry determined during the multiplication operation X₁·Y₁Y₀ (performed by MUL unit 220-2 during cycle 2) to an accumulator value determined during the multiplication operation X₁·Y₃ Y₂ (performed by MUL unit 220-2 during cycle 3) and to the product of the multiplication operation X₂·Y₁Y₀ (performed by MUL unit 220-3 during cycle 3).

In some implementations, each of the first plurality of multiplication products and the second plurality of multiplication products may be modular multiplication products. In some implementations, each of the second plurality of multiplication products may be obtained by a Montgomery reduction of a respective multiplication product of the first plurality of multiplication products. For example, while MUL unit 220-1 may be computing a multiplication product during the first cycle, MUL unit 220-2 may be performing (during the second cycle) the Montgomery reduction of the computed product.

FIG. 6 is a flow diagram depicting another method 600 of a streaming multiplication performed on a cryptographic processor that operates in accordance with one or more aspects of the present disclosure. Method 600 is sometimes illustrated below using a non-limiting example of operations shown in FIG. 2A, FIG. 2B, and FIG. 2C, but it will be understood that various other implementations of method 600 are possible. At block 610, the cryptographic processor performing method 600 may load (as depicted in FIG. 2A) a first multiplier (e.g., X₀) and a first multiplicand (e.g., Y₀) from the memory system into a first multiplication circuit (e.g., MUL unit 220-1) of a plurality of multiplication circuits (e.g., MUL units 220-n). In some implementations, e.g., as illustrated in FIG. 2C, a number of bits of the first multiplier (e.g., X₀) is different from a number of bits of the first multiplicand (e.g., Y₁Y₀).

At block 620, method 600 may continue with the first multiplication circuit (e.g., MUL unit 220-1) determining a first product (e.g., X₀·Y₀) of the first multiplier and the first multiplicand. At block 630, the cryptographic processor (e.g., using instructions of control unit 250 depicted in FIG. 2A) may cause the first product to be provided to at least one of a first addition circuit of the plurality of addition circuits or a second multiplication circuit (e.g., MUL unit 220-2) of the plurality of multiplication circuits. In some implementations, only a part of the determined product may be provided to a respective circuit. For example, the low word of the product X₀. Y₀ may be provided to adder circuit 235 (or some other accumulator unit) whereas the high word (carry) of the same product may be provided to MUL unit 220-2 (as depicted by the dashed arrow in FIG. 2B). In some implementations, the cryptographic processor may provide the first product to the second multiplication circuit and the second multiplication circuit may perform a Montgomery reduction operation on the first product.

At block 640, the cryptographic processor may load (e.g., in conjunction with cycle 2, as depicted in FIG. 2B) a second multiplicand (e.g., Y₁) from the memory system into the first multiplication circuit (e.g., MUL unit 220-1). At block 650, method 600 may continue with the first multiplication circuit (e.g., MUL unit 220-1) determining a second product (e.g., X₀·Y₁) of the first multiplier (e.g., X₀) and the second multiplicand (e.g., Y₁). At block 660, the cryptographic processor may load a second multiplier (e.g., X₁) from the memory system into a second multiplication circuit (e.g., MUL unit 220-2) of the plurality of multiplication circuits. In some implementations, loading of the second multiplier is performed by passing the second multiplier from the first multiplication circuit to the second multiplication circuit (for example, multiplier Y₁ is passed from MUL unit 220-2 to MUL unit 220-3 in conjunction with cycle 4 depicted in FIG. 2B).

At block 670, method 600 may continue with the second multiplication circuit (e.g., MUL unit 220-2) determining a third product (e.g., X₁. Y₀) of the second multiplier (e.g., X₁) and the first multiplicand (e.g., Y₀). At block 680, method 600 may continue with one of the addition circuits (e.g., adder circuit 235) computing a sum of addends. The addends may include: i) a first predetermined number of low bits (e.g., N bits) of the second product (e.g., X₀·Y₁), ii) the third product (e.g., X₁·Y₀), and iii) a second predetermined number (e.g., 2N bits or N bits) of high bits of the first product (e.g., X₀·Y₀). At block 690, the cryptographic processor may store the first predetermined number of low bits of the sum (e.g., accumulator value A₁) in a memory unit (e.g., SRAM 240-1 or SP 242-1). Additionally, the cryptographic processor may store the second predetermined number of high bits of the sum in at a second memory unit (e.g., ADD unit 230-2 or a buffer memory of MUL unit 220-2). The stored high bits may be used (e.g., as a carry) in a subsequent cycle of computations.

FIG. 7 is a flow diagram depicting method 700 of determining results of certain modular operations using a cryptographic processor that operates in accordance with one or more aspects of the present disclosure. The modular operations may depend on a first number (e.g., x) and a second number (e.g., y) and may include inversion of the first number modulo the second number, x⁻¹ mod y, and/or computation of Jacobi symbol of the first number modulo the second number

$$( \frac{x}{y} ) .$$

It will be understood that Jacobi symbols also include, as a special case, the Legendre symbols, which may also be computed using method 700. Method 700 may involve performing, by a cryptographic processor, a plurality of iterations to identify the result of the respective modular operation. The cryptographic processor may include a plurality of multiplication circuits and a co-processor, each performing a portion of operations of method 700.

At block 710, method 700 may include iteratively determining, by the co-processor, a plurality of k step matrices, wherein each of the plurality of step matrices is based on a respective subset of k least significant bits of the first number and the second number. For example, step matrices \hat{M}₁ and \hat{M}₂ may be based on the least significant bit and the second least significant bid of each of the first number x and the second number y. At block 720, method 700 may continue with the co-processor determining a tracking matrix as a product of the computed step matrices, e.g., \hat{M}_{1 . . . k}=Πⱼ₌₁^{k} \hat{M}ⱼ. At block 730, method 700 may continue with the plurality of multiplication circuits modifying numbers x and y using matrix multiplication with the tracking matrix, e.g.,

$$( \begin{matrix}{x}_{k} \\ {y}_{k}\end{matrix} ) = {\prod }_{j = 1}^{k} {\hat{M}}_{j} \cdot ( \begin{matrix}x \\ y\end{matrix} ) .$$

As indicated by block 740, the co-processor may determine a first number of times an element of the tracking matrix \hat{M}_{1 . . . k}, iteratively modified, becomes negative. As indicated by block 750, at each iteration, the co-processor may further determine a second number of occurrences that the second number, iteratively modified (e.g., y), becomes negative. For example, if the step matrices M; obey certain mathematical properties, the number of times that the sign of the element of \hat{M}_{1 . . . k} changes may be the same as (or one less than) the number of times that the sign of the second number (e.g., y) changes. This property, in conjunction with the final signs of the element of \hat{M}_{1 . . . k} and the second number, may be used to determine the number of times the second number changes sign (e.g., becomes negative) based on the number of times the element of \hat{M}_{1 . . . k} changes sign. At block 760, method 700 may identify the result of the modular operation using the modified first number, the modified second number, the first determined number of times and/or the second determined number of times to identify the result of the modular operation. For example, if the modular operation involves a computation of a Jacobi symbol, the sign of the result of the operation may be changed if the first number of occurrences or the second number of occurrences is odd.

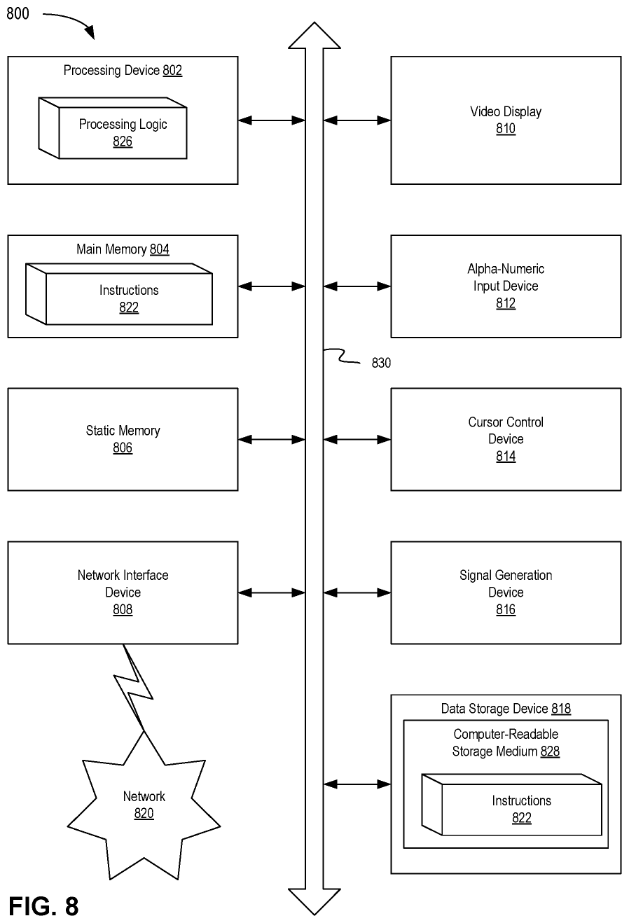

FIG. 8 depicts a block diagram of an example computer system 800 operating in accordance with one or more aspects of the present disclosure. In various illustrative examples, example computer system 800 may be computer system 102, illustrated in FIG. 1. Example computer system 800 may be connected to other computer systems in a LAN, an intranet, an extranet, and/or the Internet. Computer system 800 may operate in the capacity of a server in a client-server network environment. Computer system 800 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 800 may include a processing device 802 (also referred to as a processor or CPU), a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory (e.g., a data storage device 818), which may communicate with each other via a bus 830.

Processing device 802 represents one or more general-purpose processing devices such as a microprocessor, central processing unit, or the like. More particularly, processing device 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 802 may be configured to execute instructions implementing methods 500 and 600 of a streaming multiplication performed on a cryptographic processor operating in accordance with one or more aspects of the present disclosure and method 700 of determining results of certain modular operations using the cryptographic processor.

Example computer system 800 may further comprise a network interface device 808, which may be communicatively coupled to a network 820. Example computer system 800 may further comprise a video display 810 (e.g., a liquid crystal display (LCD), a touch screen, or a cathode ray tube (CRT)), an alphanumeric input device 812 (e.g., a keyboard), a cursor control device 814 (e.g., a mouse), and an acoustic signal generation device 816 (e.g., a speaker).

Data storage device 818 may include a computer-readable storage medium (or, more specifically, a non-transitory computer-readable storage medium) 828 on which is stored one or more sets of executable instructions 822. In accordance with one or more aspects of the present disclosure, executable instructions 822 may comprise executable instructions implementing methods 500 and 600 of a streaming multiplication performed on a cryptographic processor operating in accordance with one or more aspects of the present disclosure and method 700 of determining results of certain modular operations using the cryptographic processor.

Executable instructions 822 may also reside, completely or at least partially, within main memory 804 and/or within processing device 802 during execution thereof by example computer system 800, main memory 804 and processing device 802 also constituting computer-readable storage media. Executable instructions 822 may further be transmitted or received over a network via network interface device 808.

While the computer-readable storage medium 828 is shown in FIG. 8 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A cryptographic processor comprising:
a plurality of four or more multiplication circuits;
a plurality of two or more addition circuits, wherein each of the plurality of the addition circuits is communicatively coupled to at least one of the plurality of multiplication circuits;
a memory system comprising a plurality of at least two memory units, wherein each of the plurality of the memory units is communicatively coupled to at least one of the plurality of multiplication circuits and at least one of the plurality of addition circuits; and
a control unit configured to:
cause a first multiplier and a first multiplicand to be loaded from the memory system into a first multiplication circuit of the plurality of multiplication circuits, wherein each of the first multiplier and the first multiplicand comprise at least 128 bits of integer data;
cause the first multiplication circuit to determine a first product of the first multiplier and the first multiplicand; and
cause the first product to be provided to at least one of a first addition circuit of the plurality of addition circuits or a second multiplication circuit of the plurality of multiplication circuits.

2. The cryptographic processor of claim 1, wherein the control unit is configured responsive to instructions received from an external processor executing a cryptographic application.

3. The cryptographic processor of claim 1, wherein the control unit is further configured to:
cause a second multiplicand to be loaded from the memory system into the first multiplication circuit;
cause the first multiplication circuit to determine a second product of the first multiplier and the second multiplicand;
cause a second multiplier to be loaded from the memory system into a second multiplication circuit of the plurality of multiplication circuits;
cause the second multiplication circuit to determine a third product of the second multiplier and the first multiplicand.

4. The cryptographic processor of claim 3, wherein the second multiplier is passed from the first multiplication circuit to the second multiplication circuit.

5. The cryptographic processor of claim 3, wherein the control unit is further configured to:
cause a first addition circuit of the plurality of addition circuits to compute a sum, wherein addends of the sum comprise a first predetermined number of low bits of the second product and the third product; and
store the first predetermined number of low bits of the sum in a first memory unit of the plurality of memory units.

6. The cryptographic processor of claim 5, wherein the addends of the sum further comprise a second predetermined number of high bits of the first product, and wherein the control unit is further configured to:
store the second predetermined number of high bits of the sum in a second memory unit of the plurality of memory units.

7. The cryptographic processor of claim 1, wherein each of the plurality of multiplication circuits is configured to perform modular multiplication and each of the plurality of addition circuits is configured to perform modular addition.

8. The cryptographic processor of claim 1, wherein each of the plurality of multiplication circuits is configured to perform a Montgomery multiplication.

9. The cryptographic processor of claim 1, wherein the control unit is configured to cause the first product to be provided to the second multiplication circuit and further to:
cause the second multiplication circuit to perform a Montgomery reduction operation on the first product.

10. The cryptographic processor of claim 1, wherein a number of bits of the first multiplier is different from a number of bits of the first multiplicand.

11. The cryptographic processor of claim 1, wherein one or more memory units of the plurality of memory units are double-port memory units capable of performing a read operation and a write operation within a same cycle of the cryptographic processor.

12. A cryptographic processor comprising:
a plurality of four or more multiplication circuits, wherein each of the plurality of multiplication circuits is to:
during a first cycle, obtain a first plurality of multiplication products, wherein each of the first plurality of multiplication products is obtained by a respective one of the plurality of multiplication circuits based on multiplier and multiplicand inputs that are at least 128 bits of integer data; and
during a second cycle, obtain a second plurality of multiplication products, wherein each of the second plurality of multiplication products is obtained by a respective multiplication circuit of at least a subset of the plurality of multiplication circuits and is based on a multiplier or a multiplicand used, during the first cycle, by a different multiplication circuit.

13. The cryptographic processor of claim 12, further comprising:
a plurality of two or more addition circuits, wherein at least one of the plurality of addition circuits is configured to:
perform an addition operation using at least one of the first plurality of multiplication products and at least one of the second plurality of multiplication products.

14. The cryptographic processor of claim 12, further comprising:
a plurality of memory circuits, wherein at least some of the first plurality of multiplication products or the second plurality of multiplication products are obtained using multipliers or multiplicands loaded from the memory circuits.

15. The cryptographic processor of claim 12, wherein each of the first plurality of multiplication products and the second plurality of multiplication products are modular multiplication products.

16. The cryptographic processor of claim 12, wherein each of the second plurality of multiplication products is obtained by Montgomery reduction of a respective multiplication product of the first plurality of multiplication products.

17. A cryptographic processor configured to perform a plurality of iterations to identify a result of a modular operation on a first number and a second number, the cryptographic processor comprising:
a plurality of multiplication circuits to modify the first number and the second number using a matrix multiplication with a tracking matrix; and
a co-processor to:
iteratively determine a plurality of k step matrices, wherein each of the plurality of step matrices is based on a respective subset of k least significant bits of the first number and the second number; and
determine the tracking matrix comprising a product of the plurality of step matrices.

18. The cryptographic processor of claim 17, wherein the modular operation is at least one of i) inversion of the first number modulo the second number or ii) computation of Jacobi symbol of the first number modulo the second number.

19. The cryptographic processor of claim 17, wherein the co-processor is further to:
determine a number of times an element of the tracking matrix becomes negative; and
identify the result of the modular operation using the determined number of times.

20. The cryptographic processor of claim 17, wherein the co-processor is further to:
determine a number of times that the second number, iteratively modified, becomes negative; and
identify the result of the modular operation using the determined number of times.

21. The cryptographic processor of claim 17, wherein the plurality of multiplication circuits comprises at least four multiplication circuits.
